(19) United States
(12) Patent Application Publication
(10) Pub. No.: US 2022/0357522 A1
(43) Pub. Date: Nov. 10, 2022

(54) METHODS FOR PROCESSING FIBER OPTIC CONNECTOR COMPONENTS

(71) Applicant: COMMSCOPE TECHNOLOGIES LLC, Hickory, NC (US)

(72) Inventors: Laurens Izaäk VAN WUIJCKHUIJSE, Eden Prairie, MN (US); Aaron B. DANNEN, Minneapolis, MN (US); Samuel Taylor FINNEGAN, Eden Prairie, MN (US)

(73) Assignee: COMMSCOPE TECHNOLOGIES LLC, Hickory, NC (US)

(21) Appl. No.: 17/621,167

(22) PCT Filed: Jun. 18, 2020
(86) PCT No.: PCT/US2020/038420

§ 371 Date: Dec. 20, 2021

Related U.S. Application Data
(60) Provisional application No. 62/864,970, filed on Jun. 21, 2019.

(51) Int. Cl. G02B 6/38

(52) U.S. Cl. CPC G02B 6/3861; G02B 6/3863

(57) ABSTRACT

The present disclosure relates generally to methods for processing ferrules of fiber optic connectors such that the amount of polishing that is required is eliminated or at least reduced. In one example, a forward volume of adhesive is removed with a first laser beam having a first laser property and a front portion of the optical fiber is cleaved with a second laser beam having a second laser property that is different than the first laser property.

### CROSS-REFERENCE TO RELATED APPLICATION

This application is being filed on Jun. 18, 2020 as a PCT International Patent Application and claims the benefit of U.S. Patent Application Ser. No. 62/864,970, filed on Jun. 21, 2019, the disclosure of which is incorporated herein by reference in its entirety.

### TECHNICAL FIELD

The present disclosure relates generally to methods for processing components of fiber optic connectors. More particularly, the present disclosure relates to methods for processing ferrules and corresponding optical fibers used in fiber optic connectors.

### BACKGROUND

Fiber optic communication systems are becoming prevalent in part because service providers want to deliver high band width communication capabilities (e.g., data and voice) to customers. Fiber optic communication systems employ a network of fiber optic cables to transmit large volumes of data and voice signals over relatively long distances. Fiber optic connectors are an important part of most fiber optic communication systems. Fiber optic connectors allow optical fibers to be quickly optically connected without requiring a splice. Fiber optic connectors can include single fiber connectors and multi-fiber connectors.

A typical fiber optic connector includes a ferrule assembly supported at a distal end of a connector housing. The ferrule functions to support an end portion of at least one optical fiber (in the case of a multi-fiber ferrule, the ends of multiple fibers are supported). The ferrule has a distal end face at which a polished end of the optical fiber is located. When two fiber optic connectors are interconnected, the distal end faces of the ferrules abut one another and the ferrules are forced proximally relative to their respective connector housings against the bias of their respective springs. With the fiber optic connectors connected, their respective optical fibers are coaxially aligned such that the end faces of the optical fibers directly oppose one another. In this way, an optical signal can be transmitted from optical fiber to optical fiber through the aligned end faces of the optical fibers. U.S. Pat. No. 6,957,920, which is hereby incorporated by reference in its entirety, discloses a multi-fiber ferrule having protruding optical fibers.

The manufacturing process of optical connectors typically consists of a substantial number of steps which may include: Fiber and Cable Preparation, Epoxy and Cure, Cleave, Epoxy Removal, Polish, and others. Polishing and cleaving can greatly affect the performance of a fiber optic connector.

Polishing is a multi-step process where the end-face of the ferrule and the fiber are gradually worked and reshaped using different grade polishing materials until the desired radius, angle, flatness and surface quality (roughness) is achieved. The number of polishing steps is connector dependent, often ranging from 3 or 4 steps for simplex connectors, to 5 or 6 steps in multi-fiber connectors. Generally, polishing is time consuming, labor intensive and messy. In an effort to reduce manufacturing cycle time, reduce manufacturing complexity, and, ultimately remove manufacturing costs, it is desirable to reduce the number of steps required for polishing a connector.

### SUMMARY

One aspect of the present disclosure relates to ferrule and fiber processing methods including the use of a non-contact energy source to remove unwanted material from the end face of a ferrule and/or the tip of an optical fiber supported by the ferrule prior to performing a cleaving operation with respect to the optical fiber. In certain examples, the ferrule can be a multi-fiber ferrule or a single fiber ferrule. In certain examples, the unwanted material includes residue of an adhesive (e.g., epoxy) used to retain the optical fiber within the ferrule.

In certain examples, processing techniques using non-contact energy sources, such as lasers, can be used to remove undesired material (restudies such as adhesive (e.g., epoxy), dust, electrostatic particles, or other contaminants) from the end face of a ferrule and/or the end face of an optical fiber supported by the ferrule prior to performing a cleaving operation with respect to the optical fiber. In examples, the processing techniques can be implemented after the optical fiber has been axially fixed within the ferrule. In certain examples, the processing techniques can reduce the need for subsequent polishing steps. In other examples, the polishing required is substantially diminished or optionally eliminated.

A first aspect relates to a method for processing fiber optic assemblies adapted to be incorporated within a fiber optic connector. The fiber-optic assembly includes a ferrule and an optical fiber, the optical fiber secured within the fiber opening of the ferrule by an adhesive material. The optical fiber has a front portion that projects forward beyond the front face of the ferrule, and the adhesive material includes a forward volume of the adhesive that extends in a forward direction beyond the front face of the ferrule adjacent to the optical fiber. The method includes removing at least a portion of the forward volume of adhesive with the first laser beam having a first laser property. The front portion of the optical fiber is cleaved with a second laser beam having a second laser property, the second laser property is different than the first laser property. The cleaving occurs after the removal of the at least a portion of the forward volume of the adhesive.

Another aspect includes a method for processing a fiber optic assembly adapted to be incorporated within a fiber optic connector. The fiber-optic assembly includes a ferrule and an optical fiber, the optical fiber secured within the fiber opening of the ferrule by an adhesive material. The optical fiber has a front portion that projects forward beyond the front face of the ferrule, and the adhesive material includes a forward volume of the adhesive that extends in a forward direction beyond the front face of the ferrule adjacent to the optical fiber. The method includes removing at least a portion of the forward volume of adhesive using a non-contact energy source, and cleaving the front portion of the optical fiber, wherein the cleaving occurs after removal of the at least a portion of the forward volume the adhesive.

Yet another aspect includes a device for processing a fiber optic assembly adapted to be incorporated within a fiber optic connector. The fiber-optic assembly includes a ferrule and an optical fiber, the optical fiber secured within the fiber opening of the ferrule by an adhesive material. The optical fiber has a front portion that projects forward beyond the front face of the ferrule, and the adhesive material includes a forward volume of the adhesive that extends in a forward direction beyond the front face of the ferrule adjacent to the optical fiber. The device includes an ablation device configured to remove at least a portion of the forward volume of adhesive, and a cleaving device configured to cleave the front portion of the optical fiber.

A variety of additional aspects will be set forth in the description that follows. The aspects relate to individual features and to combinations of features. It is to be understood that both the foregoing general description and the following detailed description are exemplary and explanatory only and are not restrictive of the broad inventive concepts upon which the embodiments disclosed herein are based.

### BRIEF DESCRIPTION OF THE DRAWINGS

The following drawings are illustrative of particular embodiments of the present disclosure and therefore do not limit the scope of the present disclosure. The drawings are not to scale and are intended for use in conjunction with the explanations in the following detailed description. Embodiments of the present disclosure will hereinafter be described in conjunction with the appended drawings, wherein like numerals denote like elements.

FIG. 1 is a front, perspective, cross-sectional view of a ferrule assembly in accordance with the principles of the present disclosure.

FIGS. 2-7 illustrate a sequence of steps for securing the optical fiber within a ferrule in accordance with the principles of the present disclosure.

FIG. 8 illustrates another embodiment of a ferrule having a forward volume of adhesive.

FIG. 9 is a schematic view showing laser beams at two different angles.

FIG. 10 is a schematic view showing two laser beam sources at two different angles.

FIG. 11 is a schematic view showing a laser beam.

FIG. 12 is a schematic view showing laser beams at two different angles.

FIG. 13 is a flow chart illustrating a method for processing the optical fiber including in accordance with the principles of the present disclosure.

### DETAILED DESCRIPTION

Aspects of the present disclosure relate to the effective use of non-contact energy source treatment techniques to simplify operations and reduce cost associated with manufacturing an optical component including a ferrule supporting an optical fiber. Traditionally, the significant reliance upon mechanical polishing operations including abrasives (e.g., abrasive flocks, abrasive slurries, abrasive pads or discs, etc.) results in substantial cost and complexity associated with processing optical fibers and their corresponding ferrules. Certain aspects of the present disclosure relate to the use of non-contact energy source treatment techniques to replace one or more mechanical polishing steps. Certain aspects relate to ferrule and optical fiber processing methods. Other aspects relate to ferrule and fiber processing methods that reduce the number, complexity, or abrasiveness of the mechanical polishing steps used. Processes of the present disclosure are applicable to single fiber ferrules and multi-fiber ferrules.

As used herein, non-contact energy source treatment techniques relate to treatment techniques that do not require direct mechanical contact with the contact ferrule/optical fiber but instead involve exposing the ferule and/or optical fiber to an energy source which brings about a desired treatment result. An example non-contact energy source treatment technique involves exposing the ferrule and/or optical fiber to a laser beam. An example device for generating such a laser beam includes gas laser devices such as CO₂ lasers or excimer lasers. Example excimer lasers include ArF, KrF, XeCl, and XeF lasers. Lasers can also include green lasers, fiber lasers and hybrid lasers. Example wavelengths of the lasers that may be used include ultraviolet, visible, near infrared, and mid-infrared. Other types of non-contact energy sources include plasma discharges, lasers, torches, and infrared heating.

The various methods disclosed herein can be used to manufacture ferrule/fiber assemblies having optical fiber tips that project distally beyond an end face of the ferrule. In the case of single fiber ferrules, in certain examples, a final fixed tip position of the optical fiber can be less than or equal to 15 nanometers or 12 nanometers, or 10 nanometers relative to an end face of the ferrule.

One aspect of the present disclosure relates to the use of a non-contact energy source to remove unwanted material from the end face of a ferrule and/or the tip of an optical fiber supported by the ferrule. In certain examples, the ferrule can be a multi-fiber ferrule or a single fiber ferrule. In certain examples, the unwanted material includes residue of an adhesive (e.g., epoxy) used to retain an optical fiber within the ferrule. In certain examples, the end face cleaning allows the optical fiber to be cleaved within at least 15 microns, or within at least 12 microns, or at least 10 microns of the end face of the ferrule. After cleaving, the optical fiber and ferrule end faces can be subject to polishing (e.g., final polishing operations) to further reduce the projection height of the optical fiber to the final projection height (e.g., less than or equal to 15, 12, or 10 nanometers).

In certain examples, the removal of the unwanted materials (e.g., adhesive) using the non-contact energy source can be an intermediate step in preparing the end face of the ferrule and/or the fiber tip so as to simplify subsequent steps. In such examples, after material has been removed using the non-contact energy source, the end of the ferrule and/or the optical fiber tip can be subsequently processed using further non-contact energy source applications and/or mechanical polishing techniques to further process the end of the ferrule and/or the fiber tip. Such subsequent processing steps can be used to control the degree of protrusion of the optical fiber (e.g., laser ablation can be used to remove material of the ferrule to increase fiber protrusion or can be used to remove material from the optical fiber to decrease fiber protrusion). Such subsequent processing steps (mechanical polishing) can also be used to modify the fiber tip shape and/or the ferrule end shape (e.g., the ferrule can be stepped, the ferrule can be rounded, the ferrule end surface and the fiber tip can be angled, the fiber tip can be treated to remove imperfections, the fiber tip can be rounded to a desired tip radius, etc.).

Another aspect of the present disclosure relates to the use of a non-contact energy source to process the fiber tip of an optical fiber after the optical fiber has been secured in a ferrule. For example, the non-contact energy source can be used to shape the fiber tip after the optical fiber has been secured to within the ferrule. Shaping the fiber tip can include modifying the fiber tip to include at least some curvature. In certain examples, the fiber tip and the ferrule end are modified in shape so as to comply with industry standards for end face geometry. Shaping can be particularly effective for optical fibers that have been set relative to their corresponding ferrules so that the fiber tip protrudes beyond the ferrule end face, but can also be used for flush and recessed fiber tips. In this type of example, the non-contact processing can follow earlier processing operations (e.g., adhesive removal, polishing, ferrule removal/shaping, etc.). In other examples, the non-contact processing can be followed by subsequent processing operations (e.g., polishing, further non-contact processing, etc.).

In certain examples, a laser is used to process an end face of an optical fiber after the optical fiber is loaded into an adhesive filled fiber passage within a ferrule. Characteristics of the laser (focal spot intensity, interaction time, wave length, pulse length) are selected so that the laser effectively rounds and shapes the end face and helps remove imperfections. Laser shaping of the fiber end face can occur as part of a laser cleaving process. The laser can also be used to process the end of the ferrule to shape the ferrule, to impart structural features in to the ferule (e.g., steps) or to ablate portions of the ferrule to modify fiber protrusion lengths.

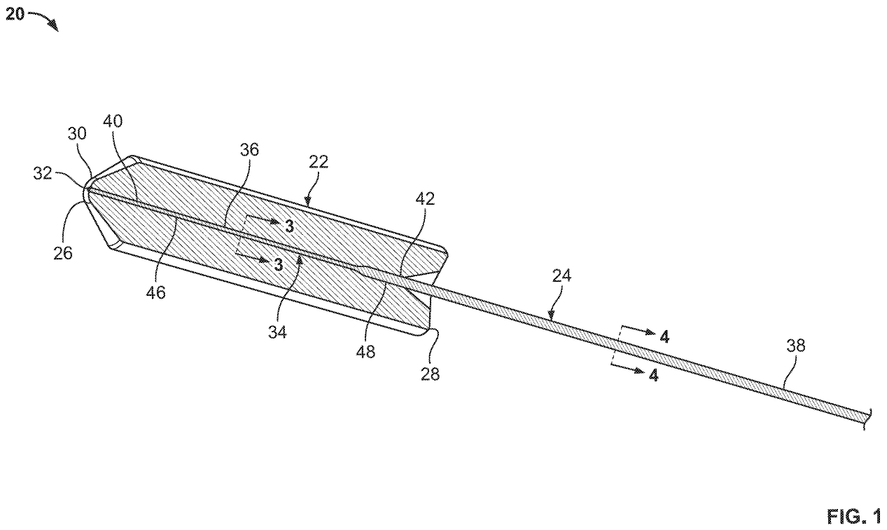

FIG. 1 illustrates an example ferrule assembly 20 which is suitable for practicing aspects of the present disclosure. The ferrule assembly 20 includes a ferrule 22 and an optical fiber 24 secured to the ferrule 22. In one example, the ferrule 22 is generally cylindrical. In one example, the ferrule has a diameter in the range of 1-3 millimeters or in the range of 1.25-2.5 millimeters. Example ferrules include SC ferrules and LC ferrules. The ferrule 22 includes a front end 26 positioned opposite from a rear end 28. The front end 26 preferably includes an end face 30 at which an interface end 32 of the optical fiber 24 is located. The ferrule 22 defines a ferrule bore 34 that extends through the ferrule 22 from the front end 26 to the rear end 28. The optical fiber 24 includes a first portion 36 secured within the ferrule bore 34 and a second portion 38 that extends rearwardly from the rear end 28 of the ferrule 22. The first portion 36 of the optical fiber 24 is preferably secured by an adhesive (e.g., epoxy) within the ferrule bore 34 of the ferrule 22. The interface end 32 preferably includes a processed end face accessible at the front end 26 of the ferrule 22.

The ferrule 22 is preferably constructed of a relatively hard material capable of protecting and supporting the first portion 36 of the optical fiber 24. In one embodiment, the ferrule 22 has a ceramic construction (e.g., zirconia). In other embodiments, the ferrule 22 can be made of alternative materials such as Ultem, thermoplastic materials such as Polyphenylene sulfide (PPS), other engineering plastics or various metals. In one example, the ferrule 22 can be a single fiber ferrule such as a ferrule for and SC connector, and ST connector, or an LC connector. While FIG. 1 depicts a single fiber ferrule, aspects of the present disclosure are also applicable to multi-fiber ferrules such as MT-ferrules and MPO ferrules. A typical multi-fiber ferrule can have a generally rectangular shape and can support a plurality of optical fibers supported in one or more rows by the multi-fiber ferrule.

The first portion 36 of the optical fiber 24 can include a bare fiber segment 46 that fits within a first bore segment 40 of the ferrule 22 and a coated fiber segment 48 that fits within a second bore segment 42 of the ferrule 22. The bare fiber segment 46 is preferably bare glass and includes a core surrounded by a cladding layer. In certain embodiments, the coated fiber segment 48 includes one or more coating layers surrounding the cladding layer. In certain embodiments, the coating layer or layers can include a polymeric material such as acrylate having an outer diameter in the range of about 190-260 microns. In still other embodiments, the coating layer/layers 51 can be surrounded by a buffer layer (e.g., a tight or loose buffer layer) having an outer diameter in the range of about 500-1100 microns.

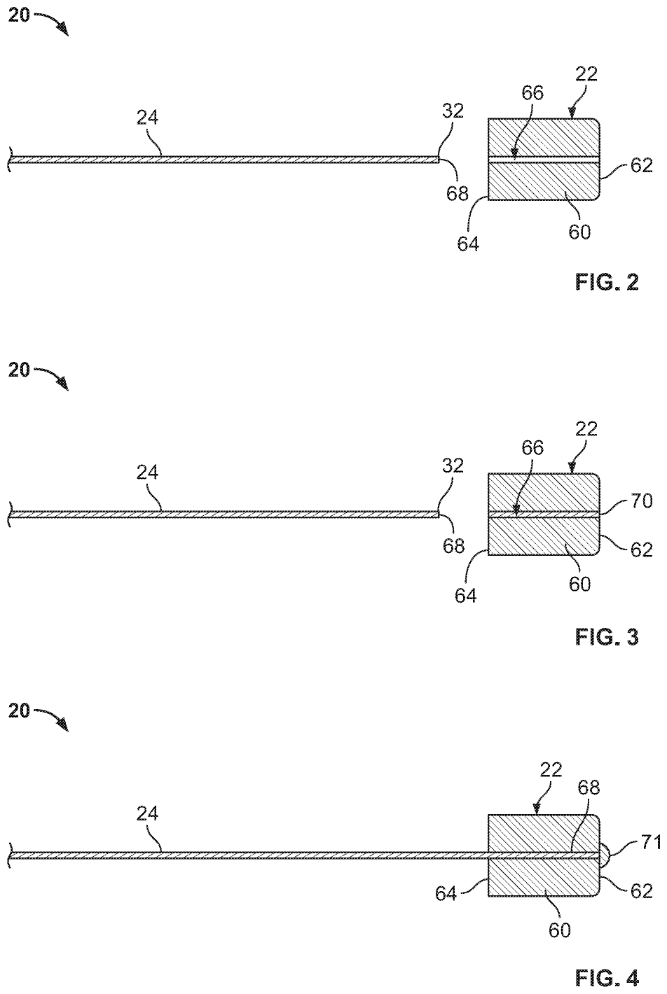

FIGS. 2-7 show a sequence of steps in accordance with the principles of the present disclosure for processing a ferrule assembly 20 including an optical fiber 24 secured to a ferrule 22.

FIG. 2 shows the example ferrule 22 including a ferrule body 60 having a distal end 62 and a proximal end 64. The ferrule body 60 defines a fiber opening 66 that extends axially through the ferrule body 60 from the proximal end 64 to the distal end 62.

As shown at FIG. 3, the fiber opening 66 of the ferrule body 60 has been filled with an adhesive 70 such as epoxy. An adhesive injection process can be used to fill the fiber opening 66 with adhesive. Once the opening 66 has been filled with the adhesive 70, the optical fiber 24 can be inserted in a distal direction through the fiber opening 66.

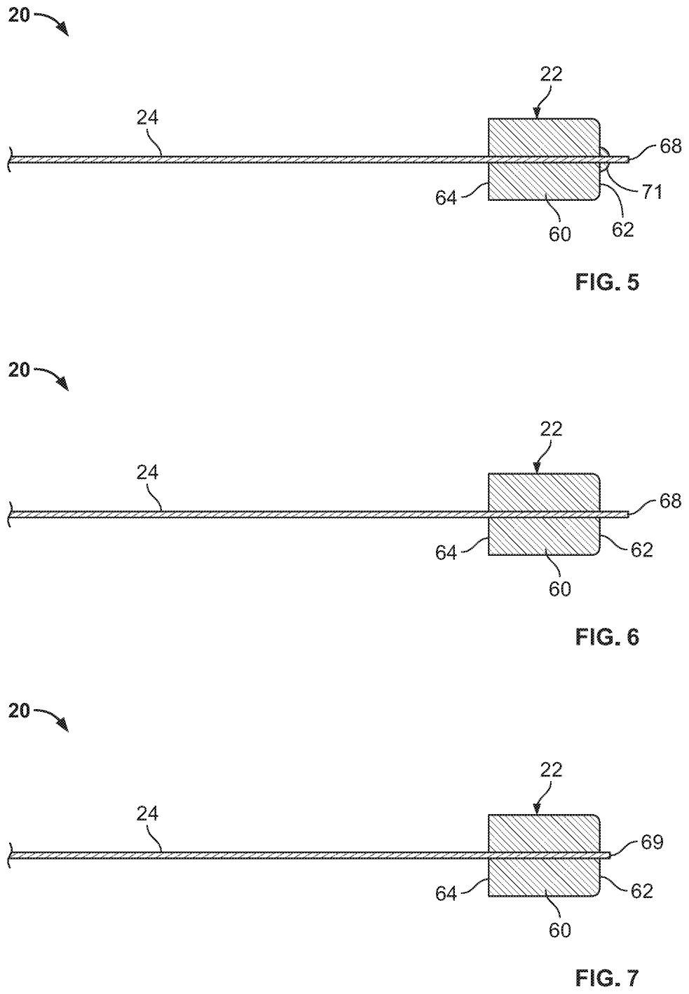

FIG. 4 shows the optical fiber 24 in the process of being inserted through the adhesive-filled opening 66 with end face 68 extending distally past/beyond the distal end 62 of the ferrule body 60. It will be appreciated that as the optical fiber 24 is moved distally through the fiber opening 66, as shown in FIG. 5, at least some of the adhesive can be distally displaced from the opening 66 and pushed out the distal end of the opening 66 or drawn from the opening 66. The forward volume of adhesive 71 can be deposited on the distal end 62 of the ferrule body 60 around the optical fiber 24, and on the end face 68 of the optical fiber 24.

FIG. 5 shows the optical fiber 24 extending distally past/beyond the distal end 62 of the ferrule body 60 with a forward volume of adhesive 71. The forward volume of adhesive 71 is located on the distal end 62 of the ferrule body 60 as a result of adhesive displacement that occurs during the fiber insertion process. A physical/mechanical wiping step can be used to remove at least some of the forward volume of adhesive 71 from the distal end of the ferrule 22 and the fiber end face 68. However, even after wiping, at least some adhesive residue will typically remain on the fiber end face 68 and on the distal end 62 of the ferrule body 60. The remaining forward volume of adhesive 71 can be removed with a first laser beam that has a first laser property. Alternatively, the wiping step can be eliminated and the first laser bean can be used to remove most or all of the forward volume of adhesive 71. In one example, the first laser can be generated by a laser device such as a MD-U1000C 3-axis UV Laser Marker sold by Keyence Corporation, which generates a laser beam having a wavelength of 355 nm and a power output at the focal point of 2.5 watts.

The first laser beam has a first laser property that enables the removal of the adhesive. In one example, the first laser beam includes a first laser property (e.g. wavelength and/or power density) selected to allow for adhesive removal while not providing meaningful removal of the ferrule and/or the optical fiber. For example, a first laser property can include a first wavelength that is less than 600 nanometers. Still further, the first laser property can include a first wavelength that is in the range of from 200 to 400 nanometers. In another example, the first laser property includes a first laser pulse width (i.e., length, duration). In one example, the first laser pulse width can be less than 10, 5, or 2 nanoseconds. In one example, the first laser property can include a peak power less than 10, 5 or 3 watts.

A first laser may be a UV laser. A UV laser may be a UV-A laser or other UV lasers such as type B or type C (e.g. UV lasers having a wavelength less than 400 nanometers). A UV laser removes or ablates excess epoxy without splattering the excess epoxy around the end face of the ferrule.

FIG. 6 shows the optical fiber 24 extending distally past/beyond the distal end 62 of the ferrule body 60 after the forward volume of adhesive 71 has been removed. The forward volume of adhesive 71 is removed with a first laser beam with a first laser property, for example, with a wavelength that is less than 600 nanometers. The wavelength and power density of the laser targets the adhesive, without disturbing the optical fiber 24. Once the forward volume of adhesive 71 has been removed, only the fiber end face 68 extends from the distal end 62 of the ferrule body 60.

FIG. 7 illustrates the optical fiber 24 after being cleaved. A front portion of the optical fiber 24 is cleaved with a second laser beam having a second laser property. The second laser property is different than the first laser property. Cleaving the optical fiber 24 occurs after removal of the adhesive.

The second laser beam has a second laser property (e.g., wavelength and/or power density) that enables cleaving of the optical fiber. In one example, the second laser property has a second wavelength that is greater than the first wavelength of the first laser property. For example, a second laser property can have a second wavelength that is greater than 2000 nanometers. Still further, the second laser property can have a second wavelength that is greater than 5,000, 7,500, 8,500, 9,500 or 10,000 nanometers or in the range of 8,00-12,000 nanometers. In one example, the second property can include a peak power greater than 20, 30 or 40 watts or in the range of 20-60 watts. In an example, the second laser property has a width greater than 10, 20, 30, 40 or 50 nanoseconds.

The second laser may be a CO₂ laser. The pre-removal of the adhesive of the face of the ferrule allows the cleaving process with the CO₂ laser to occur at a closer distance to the ferrule end, which results in a shorter fiber tip and requires less polishing.

In an example, the first laser beam is generated by a first laser source and the second laser beam is generated by a second laser source, which is different from the first laser source. As explained above, the first laser source may be a UV laser, such as an excimer laser device, and the second laser source may be a CO₂ laser.

Although not required, after cleaving the end of the optical fiber, the optical fiber may be polished. The cleaved end face 69 can be polished using one or more abrasive mechanical polishing steps. The mechanical polishing steps can provide shaping of the optical fiber 24 and/or the ferrule 22.

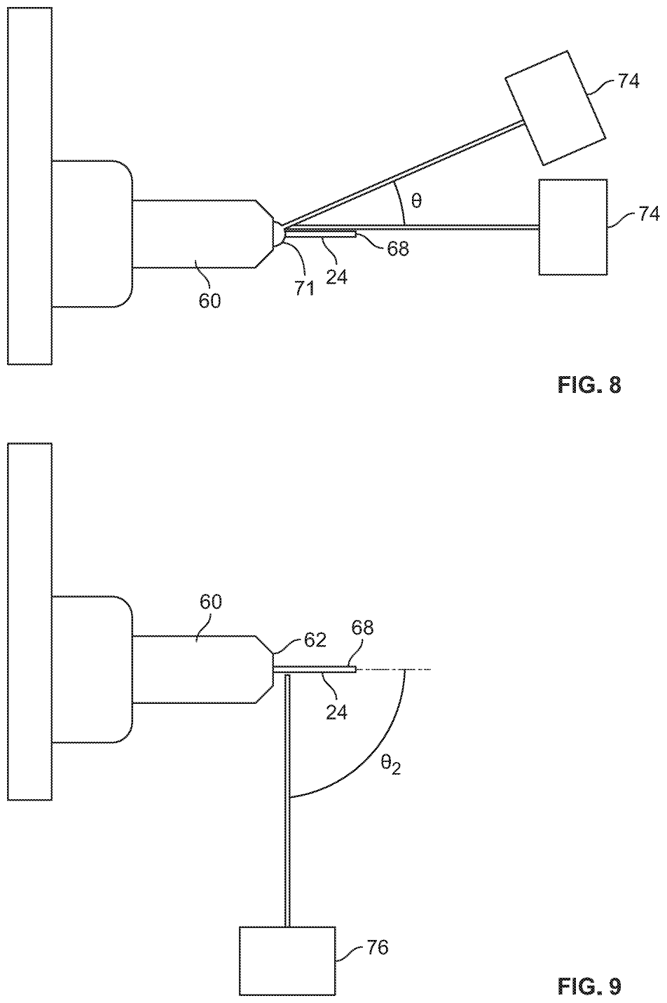

FIG. 8 shows the optical fiber 24 being exposed to a non-contact energy source 74 (e.g., laser) to remove (e.g., ablate, vaporize, etc.) a forward volume of adhesive 71 (i.e., adhesive residue) from the end face 68 of the optical fiber 24. The non-contact energy source 74 can be positioned at different locations relative to the forward volume of adhesive 71. For example, the non-contact energy source 74 may be positioned perpendicular to the ferrule 22. In another example, the non-contact energy source 74 is positioned at an angle θ relative to the optical fiber 24. For example, angle θ can be in the range of 0° to 45° relative to the axis of the fiber.

In use, the non-contact energy source 74 can be moved (e.g., rotated around the optical fiber) relative to the forward volume of adhesive 71 during the ablation process. Alternatively, the ferrule 60 can be moved (e.g., rotated) relative to the non-contact energy source 74 during the ablation process. Using the non-contact energy source leaves a clean, undamaged ferrule end face and fiber end face 68.

Epoxy within the fiber opening between the optical fiber 24 and the ferrule 22 is not removed because the ferrule 22 provides protection that prevents such adhesive from being subject to the non-contact energy source to cause removal of the adhesive.

In other examples, the above process described with respect to FIGS. 2-8 can be used in combination with one or more subsequent steps such as polishing steps. For example, polishing can be used to further shape the distal end face of the optical fiber 24 or remove imperfections from the distal end face of the optical fiber 24 after the adhesive 70 has been removed using a non-contact energy source. By using a non-contact energy source to remove adhesive from the distal end 62 of the ferrule body 60, adhesive is removed without splattering, and without affecting the optical fiber.

In still other examples, a device for processing a fiber optical assembly includes an ablation device and a cleaving device. The device may include a laser source used to ablate the forward volume of epoxy, and a laser source used to cleave the optical fiber. In other embodiments, the device used to cleave the optical fiber is a mechanical device.

FIG. 9 illustrates an embodiment of the optical fiber 24 extending distally past/beyond the distal end 62 of the ferrule body 60 with the forward volume of adhesive removed. A non-contact energy source 76, such as a laser of the type previously described, can be used to cleave the optical fiber 24 and may be positioned perpendicular to the optical fiber 24. Angle θ₂ can be in the range of 70° to 110° relative to the axis of the optical fiber 24.

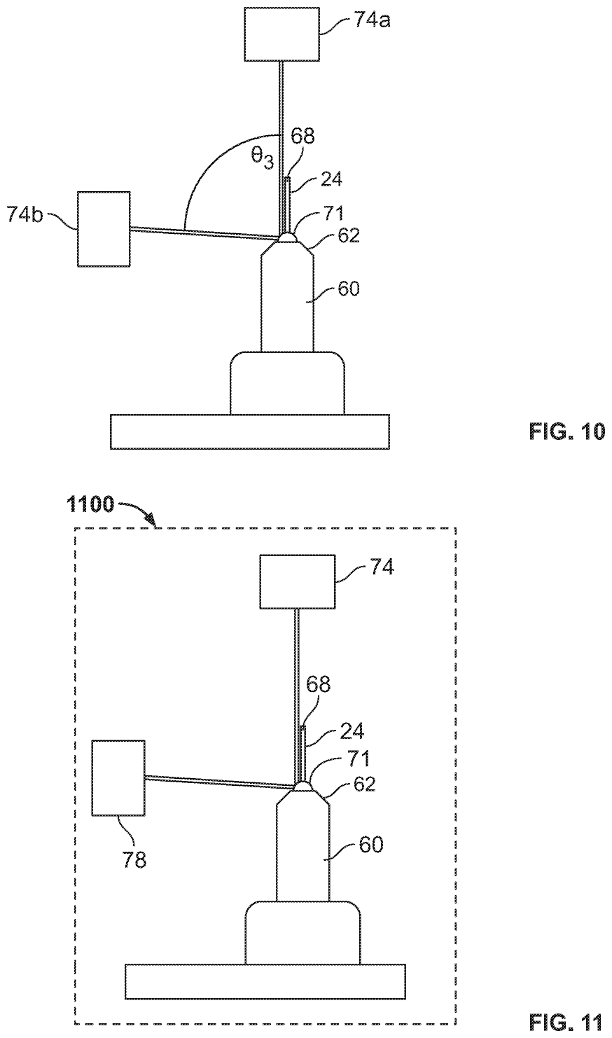

FIG. 10 shows the optical fiber 24 being exposed to a first non-contact energy source 74a (e.g., laser) to remove (e.g., ablate, vaporize, etc.) a forward volume of adhesive 71 (i.e., adhesive residue) from the end face 68 of the optical fiber 24, and a second non-contact energy source 74b (e.g., laser) to cleave the end of the optical fiber 24.

The first non-contact energy source 74a can be positioned at different locations relative to the forward volume of adhesive 71. For example, the first non-contact energy source 74a may be positioned parallel relative to the axis to the optical fiber 24.

The second non-contact energy source 74b can be positioned at different locations relative to the optical fiber 24. For example, the second non-contact energy source 74b may be positioned perpendicular relative to the axis to the optical fiber 24. Angle θ₃ can be in the range of 70° to 110° relative to the axis of the optical fiber 24.

In other examples, a device for processing a fiber optical assembly includes a single laser source. The laser source can have a first laser property used to ablate the forward volume of epoxy, and a second laser property used to cleave the optical fiber. Mirrors and filters may be used to alter the laser properties, such as the frequency, wavelength, etc.

FIG. 11 shows an example fiber optic processing device 1100. The fiber optic processing device 1100 includes an ablation device, such as a non-contact energy source 74 to remove (e.g., ablate, vaporize, etc.) a forward volume of adhesive 71 (i.e., adhesive residue) from the end face 68 of the optical fiber 24 and a cleaving device 78 to cleave the end of the optical fiber 24. The non-contact energy source 74 can be positioned at different locations relative to the forward volume of adhesive 71. For example, the non-contact energy source 74 may be positioned parallel relative to the axis to the optical fiber 24. As described above, the non-contact energy source 74 may be moved relative to the forward volume of adhesive 71 (e.g., rotated around the optical fiber) to ablate the forward volume of adhesive 71.

The cleaving device 78 may be a non-contact energy source, such as a laser cleaving device or a mechanical cleaving device such as a mechanical scribe, cleaver, or a spinning blade cleaver. In a mechanical cleaver, the optical fiber 24 can be scored and then cleaved by applying tension to the optical fiber such that a cleave is formed at the score location.

The fiber optic processing device 1100 may also include at least a first mirror, as described in more detail below. In an example fiber optic processing device 1100 comprising at least one mirror, the ablation device and the cleaving device may be a single laser.

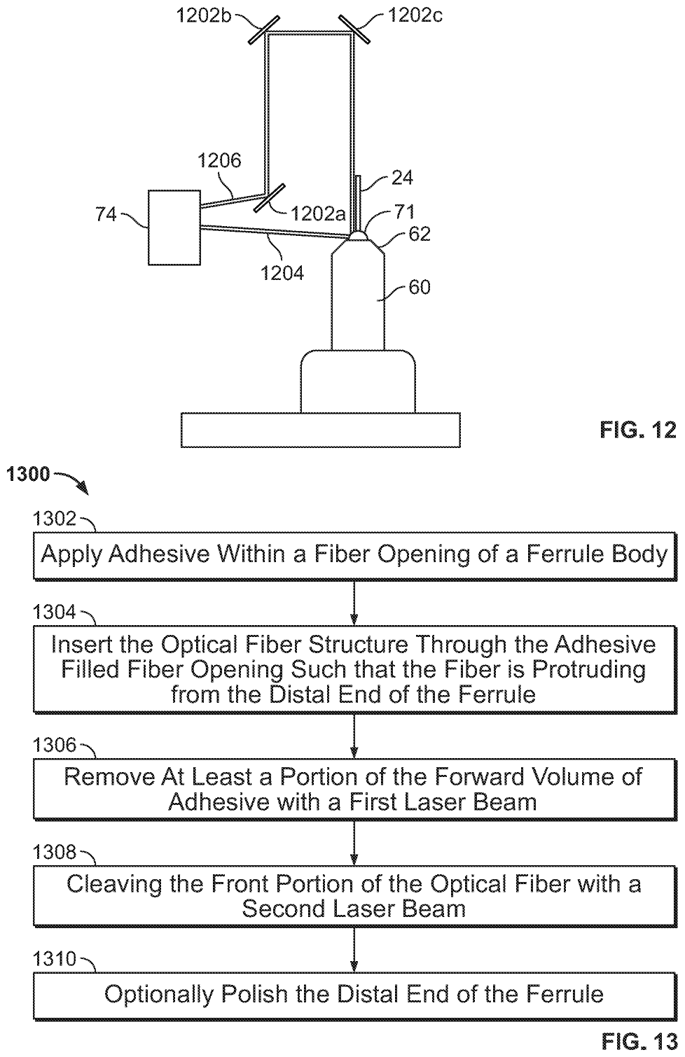

FIG. 12 shows the optical fiber 24 being exposed to a non-contact energy source 74 (e.g., laser) to remove (e.g., ablate, vaporize, etc.) a forward volume of adhesive 71 (i.e., adhesive residue) from the end face 68 of the optical fiber 24 and to cleave the end of the optical fiber 24. An ablating laser path 1206 and a cleaving laser path 1204 can have different angles relative to the optical fiber 24.

The non-contact energy source 74 can provide the ablating laser path 1206 that is positioned parallel relative to the axis to the optical fiber 24, while the non-contact energy source 74 is located perpendicular relative to the axis to the optical fiber 24. The ablating laser path 1206 is directed towards the forward volume of adhesive 71 via a series of mirrors 1202a, 1202b, 1202c.

The non-contact energy source 74 can provide the cleaving laser path 1204 in a perpendicular direction relative to the axis to the optical fiber 24

Referring to FIG. 13, a flow chart is illustrated showing an example method 1300 for processing a ferrule assembly including an optical fiber 24 such as the ferrule assembly 20b. In this example, the method includes operations 1302, 1304, 1306, 1308, and 1310.

In a first operation 1302 of the method 1300, the fiber opening defined by the ferrule is filled with adhesive (e.g., by an injection process). In a second operation 1304, the optical fiber is inserted through the adhesive filled fiber opening of the ferrule. The optical fiber can be positioned within the fiber opening such that the interface end of the optical fiber is located at a pre-determined axial position relative to the distal end of the ferrule. Alternatively, the interface end of the fiber need not be precisely positioned relative to the ferrule and can be positioned generally to protrude from the ferrule end face. In one example, the optical fiber end can be cleaved to a desired protrusion length at a later step.

At operation 1306, at least a first portion of the forward volume of adhesive is removed with a first laser beam. The first laser beam can have a first wavelength that is less than 600 nanometers. In a further example, the first laser beam can have a first wavelength that is in the range of about 200 to about 400 nanometers.

In an example, with respect to the first wavelength, the optical fiber and/or the ferrule each have an absorbance less than the absorbance of the adhesive. In another example, with respect to the first wavelength, the adhesive have an absorbance at least 10, 20, 30 or 40% greater than the absorbance of the optical fiber and/or the ferrule.

At operation 1308, the front portion of the optical fiber is cleaved with a second laser beam. The second laser beam has a second laser property that is different than the first laser property. The second laser beam can have a second wavelength that is greater than 2,000 nanometers. In another example, the second wavelength is greater than 8,500 nanometers. The second laser beam can have a power density greater than a power density of the first laser beam. In one example, the second laser beam can have a power density at least 2, 3, 4 or 5 times larger than the power density of the first laser beam. It will be appreciated that the power density of the laser beam is determined based on the power of the laser and the laser spit size. The second laser beam can have a wavelength greater than the wavelength of the first laser beam. The second laser beam can have a pulse width longer than the pulse width of the first laser beam.

Embodiments of the present invention, for example, are described above with reference to block diagrams and/or operational illustrations of methods and systems according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more embodiments provided in this application are not intended to limit or restrict the scope of the invention as claimed in any way. The embodiments, examples, and details provided in this application are considered sufficient to convey possession and enable others to make and use the best mode of claimed invention. The claimed invention should not be construed as being limited to any embodiment, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate embodiments falling within the spirit of the broader aspects of the claimed invention and the general inventive concept embodied in this application that do not depart from the broader scope.

1. A method for processing a fiber optic assembly adapted to be incorporated within a fiber optic connector, the fiber optic assembly including a ferrule and an optical fiber, the optical fiber being secured within a fiber opening of the ferrule by an adhesive material, the optical fiber having a front portion that projects forwardly beyond a front face of the ferrule, the adhesive material including a forward volume of adhesive that extends forwardly beyond the front face of the ferrule adjacent to the optical fiber, the method comprising:
removing at least a portion of the forward volume of adhesive with a first laser beam having a first laser property; and
cleaving the front portion of the optical fiber with a second laser beam having a second laser property that is different than the first laser property, wherein the cleaving occurs after removal of the at least a portion of the forward volume the adhesive.

2. The method of claim 1, wherein the first laser property is a first wavelength and the second laser property is a second wavelength.

3. The method of claim 2, wherein the first wavelength is less than the second wavelength.

4. The method of claim 3, wherein the first wavelength is less than 600 nanometers.

5. The method of claim 3, wherein the first wavelength is in the range of 200-400 nanometers.

6. The method of claim 4, wherein the second wavelength is greater than 2000 nanometers.

7. The method of claim 4, wherein the second wavelength is greater than 8,500 nanometers.

8. The method of claim 1, wherein the first laser property is a first laser pulse length and the second laser property is a second laser pulse length.

9. The method of claim 1, further comprising polishing the front end face of the ferrule after cleaving of the front portion of the optical fiber.

10. The method of claim 1, wherein the front portion of the optical fiber is cleaved at a location within 15 microns of the front face of the ferrule.

11. The method of claim 2, wherein the optical fiber and the ferrule each have an absorbance with respect to the first wavelength that is less than an absorbance of the adhesive.

12. The method of claim 1, wherein the first laser beam is generated by a first laser source and the second laser beam is generated by a second laser source different from the first laser source.

13. The method of claim 12, wherein the first laser source is an excimer laser device and the second laser source is a carbon dioxide laser device.

14. A method for processing a fiber optic assembly adapted to be incorporated within a fiber optic connector, the fiber optic assembly including a ferrule and an optical fiber, the optical fiber being secured within a fiber opening of the ferrule by an adhesive material, the optical fiber having a front portion that projects forwardly beyond a front face of the ferrule, the adhesive material including a forward volume of adhesive that extends forwardly beyond the front face of the ferrule adjacent to the optical fiber, the method comprising:
removing at least a portion of the forward volume of adhesive using a non-contact energy source; and
cleaving the front portion of the optical fiber, wherein the cleaving occurs after removal of the at least a portion of the forward volume the adhesive.

15. The method of claim 14, wherein the portion of the forward volume of adhesive is removed with a first laser beam having a first laser property.

16. The method of claim 15, wherein the front portion of the optical fiber is cleaved with a second laser beam having a second laser property.

17. The method of claim 15, wherein the front portion of the optical fiber is cleaved with a mechanical cleaving device.

18. The method of claim 14, wherein the portion of the forward volume of adhesive is removed with a laser beam having a first laser property and the front portion of the optical fiber is cleaved with the laser beam having a second laser property.

19. The method of claim 16, wherein the first laser property is a first wavelength and the second laser property is a second wavelength.

20. The method of claim 19, wherein the first wavelength is less than the second wavelength.

21. The method of claim 20, wherein the first wavelength is less than 600 nanometers.

22. The method of claim 20, wherein the first wavelength is in the range of 200-400 nanometers.

23. The method of claim 21, wherein the second wavelength is greater than 2000 nanometers.

24. The method of claim 21, wherein the second wavelength is greater than 8,500 nanometers.

25. The method of claim 16, wherein the first laser property is a first laser power density and the second laser property is a second laser power density that is greater than the first laser power density.

26. The method of claim 16, further comprising polishing the front face of the ferrule after cleaving of the front portion of the optical fiber.

27. The method of claim 14, wherein the front portion of the optical fiber is cleaved at a location within 15 microns of the front face of the ferrule.

28. The method of claim 16, wherein the first laser beam is generated by a first laser source and the second laser beam is generated by a second laser source different from the first laser source.

29. The method of claim 28, wherein the first laser source is an excimer laser device and the second laser source is a carbon dioxide laser device.

30.-36. (canceled)
